(19) United States
(12) Patent Application Publication
(10) Pub. No.: US 2003/0060284 A1
(43) Pub. Date: Mar. 27, 2003

(54) Method and a system for providing interactive question-based applications

(76) Inventors: Matti Hamalainen, Espoo (FI); Ilkka Priha, Kaunianen (FI); Juho Yli-Krekola, Espoo (FI); Stephane Kugge, Kirkniemi (FI)

Correspondence Address: YOUNG & THOMPSON, 745 SOUTH 23RD STREET 2ND FLOOR, ARLINGTON, VA, 22202

(21) Appl. No.: 10/221,653

(22) PCT Filed: Mar. 19, 2001
(86) PCT No.: PCT/FI01/00274

(30) Foreign Application Priority Data
Mar. 17, 2000 (FI) 20000637

(51) Int. Cl. G09B 7/00; G09B 3/00; G06F 15/16; G06F 19/00; G06F 17/00; A63F 13/00; A63F 9/24

(52) U.S. Cl. 463/42; 709/203; 434/322

(57) ABSTRACT

The invention relates to methods and systems for providing interactive question-based applications over communication networks. According to the invention, information specifying questions and answers are stored in a first data unit, actions specifying how questions should be presented to users are stored in a second data unit, and rules specifying how presented material should be treated for display on different types of terminals are stored in a third data unit. This separation of content, functional logic, and presentation style simplifies the creation of new questionnaires and their delivery to different terminals over different communication networks.

### BACKGROUND OF THE INVENTION

1. Field of the Invention

The invention relates to methods, systems and computer program products for providing interactive question-based applications using data communication networks. Especially, the invention is related to such a method, system and computer product as specified in the preamble of the independent claims.

2. Description of Related Art

Different types of questionnaires, voting systems and interactive games, which can be used over data communication networks, are in use. The prior art solutions for creating questionnaires and other interactive question-based applications have, however, many drawbacks. In one typical approach, the questions and the logic how questions are presented to users, i.e. the behavior of a questionnaire, is hard coded into the program performing the questionnaires, making the creation of new questionnaires difficult and time consuming. Some systems exist, in which changeable sets of questions can be presented through a fixed front-end, displaying the questions in a fixed, predefined format. In such systems the changing of questions is relatively straightforward, but changing of the behavior of the questionnaires is burdensome. Typical questionnaire systems can only be used by one type of terminals, for which a particular questionnaire system is created.

It is possible to make, for example, a questionnaire form using HTML (HyperText Markup Language). Various logical elements are defined in HTML. A questionnaire having certain information content and certain structure may be specified using HTML tags placed properly in a file specifying the information content. Typically such HTML questionnaires are static, so that a same questionnaire is presented to all users. Furthermore, there is need for a dedicated program in the server, which processes answers to a specific HTML questionnaire. If there is need to present the same questionnaire to users of, for example, WAP (Wireless Application Protocol enabled mobile devices, typically a second version of the questionnaire has to be provided using proper WML (Wireless Markup Language) tags.

Structured documents are known from creating and presenting information. A structured document is a document, where the information content of the document and the format, in which the document is presented to a user, are separated from the logical structure of the document. The use of structured documents has many advantages: By explicitly marking the logical structure (elements) of a document, we enable computer programs to identify and automatically process the elements, such as search for certain elements and convert to different presentation formats. Documents can be transformed, merged, and edited automatically. Also, it is easy to convert from one structured document to another.

In interactive applications, the use of a more advanced structured questionnaire form than a HMTL/WML form may ease the problems related to presenting a static questionnaire to users and to specifying new content for an existing static questionnaire. It does not, however, resolve the problems relating to processing the answers of the questionnaires or, in more versatile interactive applications than static questionnaires, to controlling online behaviour of the application.

### SUMMARY OF THE INVASION

An object of the invention is to provide a flexible method, system and computer program product for providing interactive question-based applications, an example of such an interactive question-based application being displaying questionnaires, obtaining answers and giving feedback to users. Advantageously easy creation of new interactive question-based applications is enabled.

The objects are reached by separation of information content, application behavior, and presentation style from each other. This allows easy creation of questions, of behavior and feedback logic, and easy integration of different types of terminals to the questionnaire system.

A method according to the invention is characterized by that, which is specified in the characterizing part of the independent method claim. A system according to the invention is characterized by that, which is specified in the characterizing part of the independent system claim. A computer program product according to the invention is characterized by that, which is specified in the characterizing part of the independent claim directed to a computer program product. The dependent claims describe some advantageous embodiments of the invention.

According to the invention, information specifying questions and answers are stored in a first data unit, actions specifying how questions and other information should be presented to users are stored in a second data unit, and rules specifying how presented material should be treated for display on different types of terminals are stored in a third data units. These first, second and third data units are logically separate data units, which are typically implemented for example, as separate files or as separate entries in a database. Alternatively it is possible that a first, second and/or third data unit are implemented by using a single file or a single database entry, where all data units reside. Also in this second option, as the data units are logically separated from each other and they can be easily identified and, for example, modified independently of each other, they are separate data units.

The separation of content, functional logic of an interactive question-based application, and presentation style simplifies the creation of new interactive question-based applications, such as new questionnaires. The separation of content allows, for example, easy and straightforward modification of the content. This means that it is possible easily to provide localized content for interactive question-based applications, for example, by modifying the facts present in the information or by changing the language, in which the content is provided. The separation of presentation style enables straightforward presentation of an interactive question-based application using various end-user devices.

The separation of the functional logic of an interactive question-based application from the content and presentation, allows, for example, that certain information content may be used in various interactive question-based applications. One advantage of the separation is thus that the re-use of information content is enhanced: it is possible, for example, to use certain first data unit comprising certain information content in connection with various interactive question-based applications, i.e. with various second data units. A second advantage is that it is easy to modify a functional logic of a certain existing interactive question-based application to produce a new or modified interactive question-based application. As the content and presentation are separated from the functional logic, the risk of causing a problem to presenting an application or modifying inadvertently the content of an application is minimal.

In some advantageous embodiments of the invention, the functional logic of interactive question-based applications is described using certain basic actions. This allows the functionality of various applications to be described unambiguously using the same basic actions. By choosing these basic actions properly, it is possible to provide basic actions, which allow the construction of various interactive question-based applications, such as questionnaires, various examinations, or question-and-answer games. The functional logic of an interactive question-based application relates, for example, to rules of a certain game.

Furthermore, to construct a new game or other interactive question-based application using the specified basic actions is more straightforward than, for example, programming a new game from scratch. It is possible that the actions relating to a certain interactive question-based application are online compiled to some generic actions carried out by a computer. Alternatively, it is possible that the description of an interactive application using certain basic actions is used as an unambiguous specification for programming an application, which behaves as specified by the description of the interactive application. Even in this case the use of unambiguous description of functional logic provides a major advantage over a non-formal description of functional logic: a non-formal description, for example a description in a natural language such as in English, typically leaves room for misunderstandings or may be otherwise ambiguous. Importantly, such a non-formal description cannot be used as a basis for automatic processing, such as transformation of the description to a functioning application. One of the most advantageous features of using an unambiguous description of functional logic is thus that this makes it possible for a machine to carry out operations that in unstructured case would require human processing.

A further advantage of the invention is that providing basic actions for constructing logic of interactive question-based applications also makes it possible to construct tools for creating and editing interactive question-based applications by end-users who need not know the details of the implementation languages.

### BRIEF DESCRIPTION OF THE DRAWINGS

Various embodiments of the invention will be described in detail below, by way of example only, with reference to the accompanying drawings, where

FIG. 1 illustrates schematically the separation of content and functional logic of an interactive question-based application in accordance with the invention,

FIG. 2 illustrates, as an example, one method according to the invention,

FIG. 3 illustrates, as an example, schematically a system for providing interactive question-based applications,

FIG. 4 illustrates the role and relationship of various data units in accordance with the invention,

FIG. 5 illustrates, as an example, an action data unit relating to a simple questionnaire,

FIG. 6a illustrates, as an example, a first part of a content data unit relating to said simple questionnaire,

FIG. 6b illustrates, as an example, a second part of the content data unit illustrated in FIG. 6a,

FIG. 7 illustrates, as an example, the actions, which a system in accordance with the invention carries out when it processes the action data unit illustrated in FIG. 5 and the content data unit illustrated in FIGS. 6a and 6b, and

FIG. 8 illustrates a system according to an advantageous embodiment of the invention.

### DETAILED DESCRIPTION OF THE INVENTION

1. A First Group of Advantageous Embodiments

According to a first aspect of the invention, a method for providing an interactive question-based application over a communications network is provided. The communication network may be for example, a packet data network or a mobile network. The interactive question-based application may be, for example, a questionnaire, where questions are presented to a user and answers are retrieved. According to an advantageous embodiment of the invention,

at least one question is defined in a data unit 10 of a first type,

at least one action for processing questions in a data unit of the first type for producing presentable questions are defined in a data unit 20 of a second type, and

rules for processing presentable questions for display on a specific type of terming are defined in a data unit of a third type.

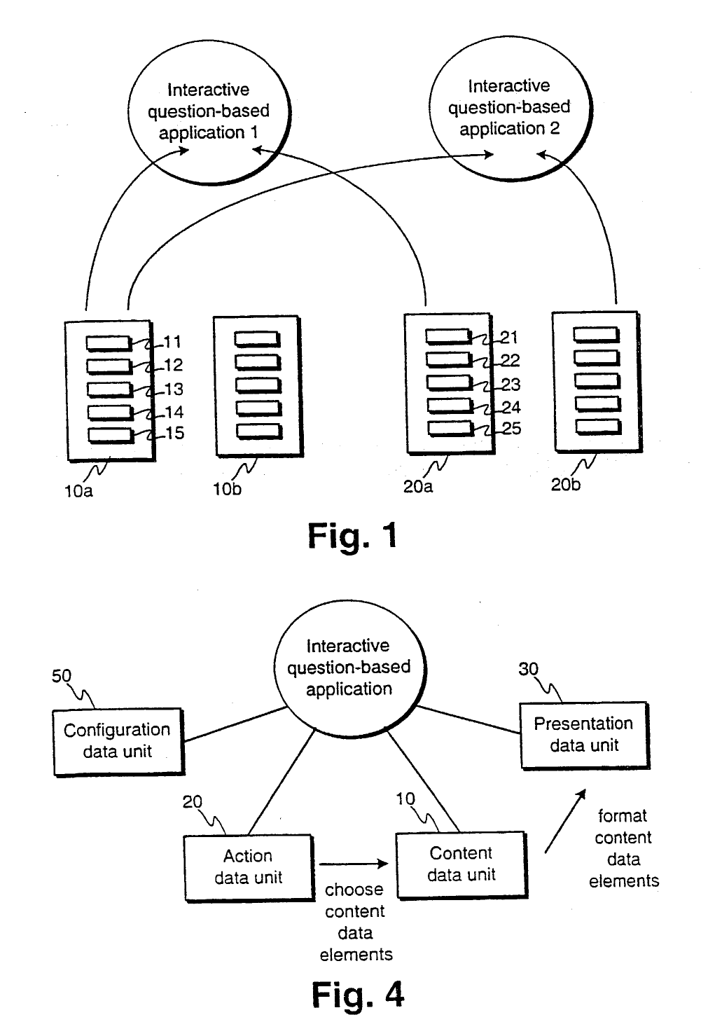

FIG. 1 illustrates schematically the separation of content and functional logic. In FIG. 1 two data units 10a, 10b of the first type, that is data units comprising content relating to interactive question-based applications, are illustrated. These first data units 10a, 10b comprise content data elements 11-15. Typically a content data element comprises a data fragment defining at least a question to be presented to a user. A content data element may have a data fragment defining a category of the question and typically it has a data fragment defining an identifier for the content data element. Furthermore, a content data element may comprise a plurality of data fragments defining some answer alternatives to be presented to a user. A content data element may comprise a data fragment defining a correct answer. Additionally, a data element 11-15 may comprise data fragments defining scoring information and/or feedback information relating to, for example, each answer alternative, which is presented to a user, or a data fragment defining scoring information and/or feedback information relating to a correct answer. Typically a data element 11-15 specifies—either explicitly using certain specific data fragments or implicitly using only the data elements described above—a question type, examples of which are a multi-choice question, a single-choice question or question, to which a free-text answer is expected. Examples of these content data fragments are illustrated below in connection with a content data element example. Some content data elements may comprise only data fragments defining feedback. Such content data elements are often presented to a user at the end of a interactive question-based application.

Two data units 20a, 20b of the second type are also illustrated in FIG. 1. These second data units 20a, 20b correspond to functional logic of different interactive question-based applications, for example, to two different games having different rules. The data units 20a, 20b comprise action data elements 21-25, which are typically processed in a sequential order. An action data element may define, for example, one or more of the following actions: selection of one content data element (typically a question or feedback) from a content data unit; selection of a plurality of content data elements (for example, selection of a certain number of questions from a certain category or categories) from a content data unit; presentation of selected content data element(s) to a user; retrieval of user input to a presented content data element or elements; rules for calculating of scores (scoring model); or calculation of scores. Examples of these action data fragments are illustrated below in connection with an action data element example.

The two circles in FIG. 1 illustrate, as examples, two interactive question-based applications, which are provided using data units 10a, 10b, 20a and 20b. The content data elements defined in data unit 10a may be combined with functional logic defined in data unit 20a, resulting in a first interactive question-based application. In this first application, the questions may be, for example, presented to a user one by one and the difficulty level of the questions may be increasing. The difficulty level may be defined in content data elements using specific content data fragments. The same content data elements defined in data unit 10a may be combined with functional logic defined in data unit 20b to produce a second interactive question-based application. This easy use of content defined in data unit 10a is an example of re-use of content information, which is one of the advantages of the invention.

It is evident that content defined in data unit 10b may typically be combined similarly with functional logics defined in data elements 20a and 20b. The content defined in data unit 10a may be, for example, specific to certain first geographical region and the content defined in data element 10b may be specific to a second geographical region. This is an example of providing localized content in a straightforward and easy manner. Alternatively, the factual content in data units 10a and 10b may be the same, but the language in which the questions, answer alternatives, correct answers and/or feedback is specified, may be different. This is an example of providing an interactive question-based application in various languages in an easy manner.

According to a further advantageous embodiment of the invention, said at least one question in data units of the first type is defined in a first computer language, said actions for processing are defined in data units of the second type in a second computer language, and said rules for processing a set of presentable questions are defined in data units of the third type in a third computer language.

According to a further advantageous embodiment of the invention, answers obtained as a result of displaying questions are stored in a fourth computer language.

According to a further advantageous embodiment of the invention, said first, second, third, and fourth computer languages are defined in the Extensible Markup Language (XML). XML is a meta language, using which it is possible to define application specific languages. XML is a well-defined standard language, and there exist XML parsers and XML formatters. Therefore it may be advantageous to use an XML-based language for defining especially functional logic of an application, as a specification written in XML-based language to be converted into generic actions to be carried out by computers. This means that it is possible to interpret a file containing XML-based language and modify the behaviour of the application accordingly even at execution time, i.e. when the application is executed. The data fragments discussed above are typically some basic structures defined in XML for use in an action data unit and/or in a content data unit. The data elements discussed above are typically constituted of a combination of data fragments and information specifying values for at least some of the basic structures defined using the data fragments.

There exist various standard languages, which are often called style languages, for defining rules for processing information to be presented for display. Therefore the rules for processing information to be presented, including presentable questions may be defined in a data unit of a third type using a standard style language. An example of such standard style language is XSLT (XSL Transformations). XSLT is a language for transforming XML documents into other XML documents. XSLT is designed for use as part of XSL, which is a stylesheet language for XML. In addition to XSLT, XSL includes an XML vocabulary for specifying formatting. XSL specifies the styling of an XML document by using XSLT to describe how the document is transformed into another XML document that uses the formatting vocabulary. XSLT is designed for use as part of XSL, which is a stylesheet language for XML. Alternatively, it is possible to use presentation rules specifically designed for interactive question-based applications. Such presentation rules may be defined, for example, using a specific XML-based presentation language.

According to a further advantageous embodiment of the invention, the method comprises at least the steps of

processing at least a part of a data unit of the first type according to at least a pan of the definitions in a data unit of the second type for producing presentable questions,

processing said presentable questions according to at least a part of the definitions in a data unit of the third type for display on a specific type of terminal,

transmitting processed presentable questions to a terminal of said specific type.

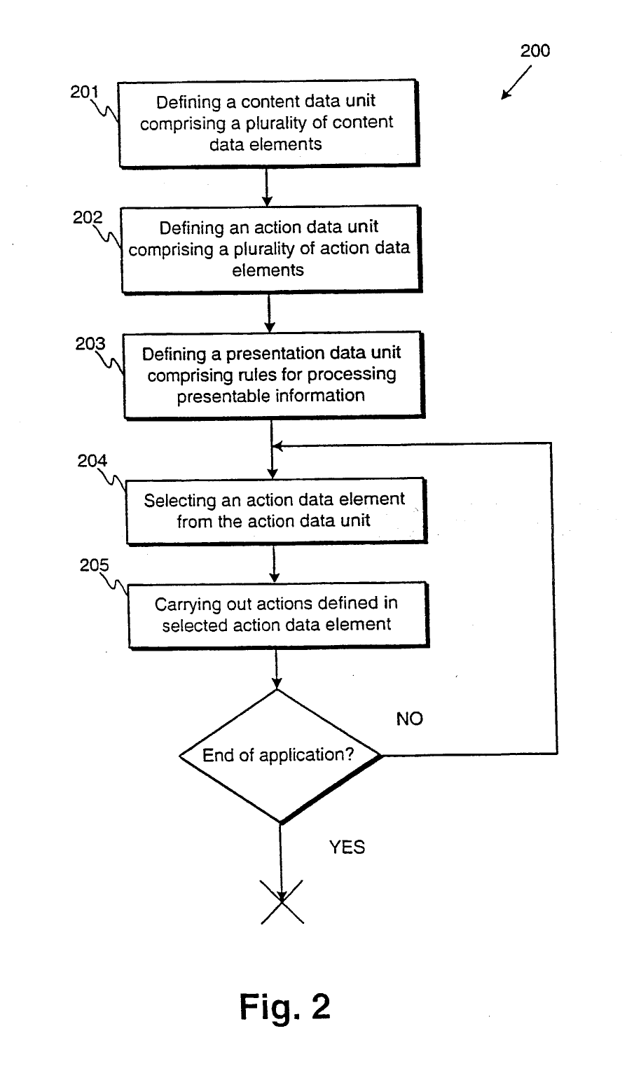

FIG. 2 illustrates an example of a method 200 according to the invention. In this method, a content data unit comprising a plurality of content data elements is defined in step 201. A question to be presented to a user is defined in at least one of these content data elements. A plurality of content data units may be defined. An action data unit comprising a plurality of action data elements defining at least some actions for processing content data elements is defined in step 202. A plurality of action data units may be defined. A presentation data unit comprising rules for processing presentable information for display on a specific type of terminal is defined in step 203. At least some of the rules relate to processing presentable questions. Steps 201-203 are carried out at least before an interactive question-based application is provided to users. If new content is to be provided or existing content is to be modified, step 201 may be carried out when the interactive question-based application is already in use. Similarly, if there is need, for example, to modify functional logic of an application, it may be possible to carry out step 202 when the application is already in use. If the presentation rules need to be modified, step 203 may be carried out when an application is already in use. It typically depends on the implementation details do these modifications affect an interactive question-based application immediately or, for example, only after the new data units are compiled. Advantageously changes made to a content or action data unit affect those interactive question-based application sessions, which are started after the modifications or creation of the content/action data unit, without any compilation or re-start of the actual application software in a system providing the applications to users.

Steps 204-205 relate to interacting with a user. An action data unit specifies the order in which the action data elements are processed, as the action data unit describes the functional behaviour of an interactive question-based application. The action data elements may be processed in a sequential order, for example in that order in which they are defined in an action data unit. Alternatively, the user input may affect, which action data elements and in which order the order are to be processed. Also in this case the action data unit describes, how the user input or feedback to user input affects the behaviour of an application; this is done with control structures defining conditional actions. In step 204 an action data element selected from the action data unit. Thereafter action specified in said selected action data element is carried out in step 205. Typically the content data unit and the rules for processing information are involved in step 205. Some examples of actions that may be carried out is step 205 are the following: selecting at least one content data element; processing selected content data element(s) using presentation rules-transmitting presentable content data element(s) to a terminal; or receiving an answer as a response to presentable content data element(s). Steps 204 and 205 are repeated until end of the interactive question-based application is encountered. A user may terminate an application, or the application may be finished as specified in the action data unit.

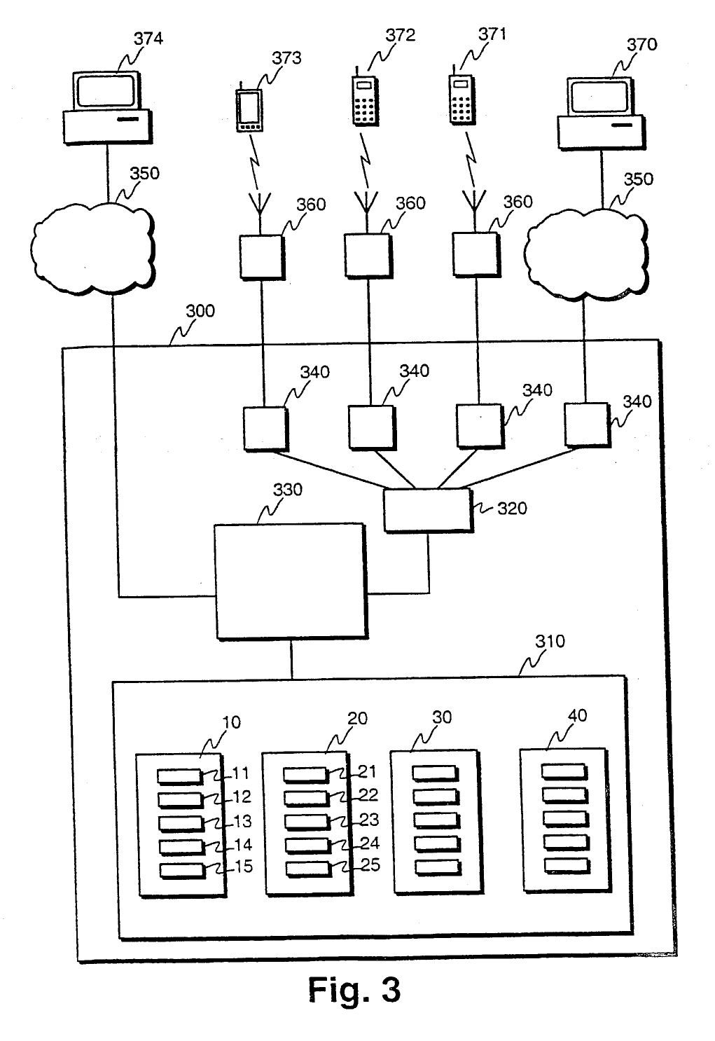

According to a second aspect of the invention, a system 300 for providing interactive question-based applications, for example for presenting questions and retrieving answers, over a communications network is provided FIG. 3 illustrates an example of such a system. According to an advantageous embodiment of the invention, said system comprises at least means for storing

a data unit 10 of a first type having the definition of at least one question,

a data unit 20 of a second type having the definition of at least one action for processing of at least one question in a first data unit and for producing at least one presentable question, and

a data unit 30 of a third type having the definition of at least one rule for processing of a presentable question for display on a specific type of terminal; and

computer code means 320 for processing at least a part of a data unit of the first type according to at least a part of the definitions in a data unit of the second type for producing presentable questions,

computer code means 340 for processing presentable questions according to at least a part of the definitions in a data unit of the third type for display on a specific type of terminal, and

computer code means for transmitting processed presentable questions to a terminal of said specific type.

A system according to the invention may implement any method according to the invention. It may implement, for example, any of those preferred embodiments described in the appended dependent method claims. In such system, the computer code means 320 and 340 are typically arranged to carry out the corresponding method steps. The data units 10 is often a data unit comprising a plurality of content data element, and the data unit 20 is often a data unit comprising a plurality of action data elements.

FIG. 3 further shows various terminals 370, 371, 372, 373, 374 of users. A user of a PDA (personal digital assistant) device 373 receives questions formatted for a PDA by computer code means 340 arranged to format material for display on a PDA. The user of a WAP (wireless application protocol) enabled mobile terminal 372 receives questions formatted for a WAP terminal. A SMS (short message service) enabled mobile phone 371 receives questions as short text messages (SMS messages). Further, the system is able to present, for example, questionnaires to a user connecting to the system via the internet 350 using his computer 370.

According to a further advantageous embodiment of the invention, the system further comprises computer program code means 330 for receiving an answer to a question displayed to a user, and computer program code means for storing received answers in a memory means 310, 40. Preferably, the answers are stored in a predefined format for easy post-processing. Typically answers are stored in data units 40 of a fourth type.

According to a further advantageous embodiment of the invention, the system further comprises computer program code means for receiving information comprising definition of a question and computer program code means for storing received information comprising definition of a question in a data unit of the first type. Such means can be used for creating new interactive question-based applications, for example questionnaires. Preferably, such means are connected to a data communications network 350 in order to allow remote users 374 to create new questions or other content and/or to modify content. Typically such computer code means for receiving information are called interfaces.

According to a further advantageous embodiment of the invention, the system further comprises computer program code means for receiving information specifying action definitions, and computer program code means for storing specified action definitions in a data unit of the second type. Such means can be used for creating new behaviors for new or already existing sets of questions. Preferably, such means are connected to a data communications network in order to allow remote users to create new behavior logics.

According to a third aspect of the invention, a computer program product for a system for providing interactive question-based applications, for example for presenting questions and retrieving answers, over a communications network is provided. According to an advantageous embodiment of the invention, the computer program product comprises at least computer program code means for storing

a data unit of a first type having the definition of at least one question,

a data unit of a second type having the definition of at least one action for processing of at least one question in a data unit of a first type and for producing at least one presentable question, and

a data unit of a third type having the definition of at least one rule for processing of a presentable question for display on a specific type of terminal; and

computer code means for processing at least a part of a data unit of the first type according to at least a part of the definitions in a data unit of the second type for producing presentable questions,

computer code means for processing presentable questions according to at least a part of the definitions in a data unit of the third type for display on a specific type of terminal and

computer code means for transmitting processed presentable questions to a terminal of said specific type.

Computer program product according to the invention may implement any method according to the invention. It may implement, for example, any of those preferred embodiments described in the appended dependent method claims.

According to a further advantageous embodiment of the invention, the computer program product is stored on a computer readable medium. The computer readable medium can be for example a hard disk or other electromagnetic mass storage medium, a CD-ROM or another optical mass storage medium, or for example a semiconductor memory element.

2. A Second Group of Advantageous Embodiments

2.1. Describing Functional Logic Unambiguously

The functional logic of interactive question-based applications may be advantageously described using certain basic actions, which are chosen properly. This allows the functionality of various interactive applications, for example the rules and behaviour of various games, to be described unambiguously using the same basic actions. Examples of game rules, which may be described, are gradually decreasing/increasing difficulty levels; selecting questions randomly or from certain specific topics; and various scoring models, even when the individual score values are part of the data unit of first type.

An example of set of basic actions in an interactive question-based applications is the following: presenting plurality of questions (one or more questions), receiving an answer to said question(s), evaluating the answer, giving feedback, selecting next action typically based on the evaluation of the answer, and allowing actions to be done by users at each different phase of an application. (for example, answering a question, asking for help, throwing a dice, saving a game or accepting a new player to a multiplayer game). Using these basic actions it is possible to construct, for example, various game logics. These basic actions typically correspond to action data elements. An action data element typically comprises a plurality of action data fragments, and same action data fragments may be used in various action data elements.

In addition to data elements defining actions, an action data unit typically comprises control structures, which define conditional actions for branching and looping. Examples of such control structures are the following control structures, which are familiar from general programming languages: while-break-structure, if-then-else-structure and switch-case-structure.

To describe the functionality of an interactive question-based application using some basic actions or basic action data elements is one way of unambiguously describing an interactive question-based application. An unambiguous description of functional logic of an interactive question-based application enables, for example, that various application concept providers may describe their applications in a uniform way. More specifically, it enables construction of an editing tool for application concept providers. A method and system, where functional description of an interactive question-based application is described unambiguously, thus allows the creation of various interactive question-based applications by various concept providers or in principle, by anybody capable of using the unambiguous description, either via an editing tool or otherwise.

One way to unambiguously describe, for example, the functionality an interactive question-based application is to describe it using a computer-processable specification language. A computer-processable specification language has an unambiguously defined syntax and semantics, therefore it may be automatically processed by a computer program and it uses the concepts of the application domain, therefore it can be easily understood and often also produced directly by a human user. The syntax determines the valid structures and sentences of a language and semantics specifies their meaning or interpretation. XML, which is briefly discussed above, is one meta language using which it is possible to define computer-processable specification languages.

In some cases it is more advantageous to use an unambiguous description of a functional logic of an interactive question-based application only as an unambiguous specification and to implement a program corresponding to said specification in a general programming language. Some examples of suitable programming languages are Java, C++, and C. Preferably, the basic actions of functional logic of an interactive question-based application are provided as software components that can be combined to implement the specified application behaviour. The use of general programming languages typically provides more efficient use of computing resources than using interpreted computer-processable specification specification languages. In some cases, it is possible to use a general programming language as a computer-processable specification language for directly describing functional logic of an application. This is especially the case, when Java is used.

2.2. Examples of XML-Based Languages for Defining Data Content and Functional Logic

The information content of the interactive question-based applications is advantageously provided in a certain format or, in other words, described in an unambiguous way. The basic features for information content may be, for example, elements specifying a question, an answer, and a feedback. There may be various types of answers: single-choise, multi-choise or free text answers. Similarly as for providing an editing tool for interactive question-based application logic, when an unambiguous way to define the logic is provided, it is possible to provide an editing tool for creating and modifying information content of interactive question-based applications.

An example of an XML-based computer-processable specification language for describing information content of an interactive question-based application is a Data Definition Language (DDL), which is specifically designed for this purpose. This subsection of the description describes DDL (Data Definition Language) syntax and structure. The terms and concepts referring to objects in a are introduced below.

In DDL, a data unit refers to all the content contained in a single DDL question set, including the header and the body. A data unit consists of one or more data elements. In DDL syntax, a data unit is everything enclosed in a ddl tag. At its fundamental level, a data element consists of pieces of information (category, data type, unique identification, correct answers and initial/default answers), and presentation or logical content (multimedia, labels, images, constants, variables) for a specific answer represented by a primitive data type (integer, double . . . ). In DDL, a data element specifies at least a question type. This data element specifying a question type can nest other data elements to form more advanced, user-defined question types and create more complex data type structures of answers. In DDL syntax the following are data elements: form int, double, long, string, boolean, date, choice and block A data fragment is the smallest piece of DDL information or content. In DDL syntax, any attributes, empty elements or text nodes are data fragments.

The ADL language (see more detailed description below), or an ADL action data unit, references DDL data fragments in two different ways: (1) Actions can directly reference a DDL data fragment by using its unique identification string if such a unique identification string exists. (2) It is also possible to represent the DDL data unit as an XML DOM tree, and access the data fragments by visiting the tree nodes sequentially or searching for a specific XML attribute or element.

The header of a DDL document (data unit) consists of information that describes the questionnaire document. This is often known as meta-information (information about the document). Below is shown a sample of a DDL header, it is actually a complete DDL document without a body. The header information is very legible, and therefore the elements and attributes of the DDL header not discussed in more detail here.

<?xml version=“1.0” encoding=“ISO-8859-1”?>
<ddl xml:lang=“en” cache=“yes”>

<title>A sample DDL questionnaire</title>
<author>

<name>CODEOnline Oy</name>
<url>www.codeonline.com</url>
<email>info@codeonline.com</email>

<author>
<timeinfo format=“yyyy-MM-dd hh:mm:ss” zone=“−2”/>
<created time=“2001-26-02 19:45:00”/>
<modified time=“2001-26-02 19:45:00”/>
<form/>

</ddl>

The body of a DDL document consists of all the data elements (questions) making up a form or a questionnaire. The questions with their correct answers and feedback are specified in the body of a DDL document. A form does not need to have correct answers and feedback, the processor could just save the answers to a database as in a survey case. Below is shown a sample of a DDL form that consists of a single data element; the form contains is a multiple-choice question type with a single answer.

<form id=“−1” type=“−1” cat=“−1”>

<choice id=“123” cat=“geography” mandatory=“true”>

<init>0</init>
<correct>1</correct>
<label>What's the capital of <emph cat=“bold”>Finland</emph>?</label>
<file mime=“image/gif”>finland.gif</file>
<boolean>

<label>Paris</label>

</boolean>
<boolean>

<label id=“h”>Helsinki</label>

</boolean>
<feedback>

<text>You answered <use this=“answer”/>.<br/></text>
<isCorrect>

<text>You know European geography!</text>
<score>10</score>

</isCorrect>
<else>

<text>Wrong ! the correct answer was <use id=“h”/>.</text>

</else>

</feedback>

</choice>

</form>

The following data fragments have the same meaning wherever in a DDL document they are used: id is optional and defines a unique identification value type is optional and specifies a type: in form it is the type of document (exam, quiz, survey, etc), in block it is the user data type of a complex block (fill-in, true-false, graphical) and in data it is the data type (integer, long, double, etc). cat is optional and defines a category, giving the purpose (business, political, game, community name, etc) of the entity it is in.

All the DDL data elements or inputs that receive a user answer are described next form defines the body of the document. It can be considered as a complex block int, double, long, string, boolean, date and choice are inputs for primitive data types, which are also called primitive blocks. They all have an XML attribute mandatory, which tells if it is mandatory to provide an answer for this block. Choice is a special block that represents a list of choices from which a single answer can be selected; the answer is the integer index of the selected choice block is used to nest blocks in order to allow a user to create more complex question types.

The following data fragments define the displayable (shown on a client terminal) and logical (processor executes operations on it: transformation, storage.) content of the form. XML element use maybe used almost anywhere in a DDL document; it is used for example in cases where there is need to insert values that are not known at request time. Those values can be client/terminal/platform-dependent and are resolved for instance after a database query or after giving a random value. With use, in addition to id, two other data fragments are used: i is used in cases when id or this are referencing a multi-valued data fragment, and it gives the index of the value to consider; and this is used to reference a data fragment of the same parent data element by calling its reserved name(correct, init, answer, file, text, data). In general, i is used to enter several values in multi-valued entities.

data is a data value of any type, and it defines constants used by the document processor to evaluate, for instance, feedback. Legal XML attributes for data are id, type and cat data can be multi-valued and should use XML element i to specify all the values. When XML element data has a single value it is defined as a child text node. The use XML element is allowed here.

file specifies the path of a resource file. It is part of the displayable content for a data element. This data fragment can be multi-valued. XML element use is allowed for file file takes an XML attribute mime in addition to id and cat mime, in turn, defines the MIME type of the content of the file.

text is a data value of type string, which is also part of the displayable content for a data element. This data fragment can be multi-valued. XML element use is allowed here. XML element emph is used as a child of XML elements text and label (explained below). Its purpose is to embed style statements inside displayable sentences br is an empty XML element, which defines a platform/terminal independent break/carriage return.

score is a short name of a data value of type double and category “score”. XML element use and XML attribute id are optional for score label is a data value of type string and category “label”. It is used to legend any input/block. XML elements use, emph and br as well as XML attribute id are legal and optional for label.

answer is a data value of same type as the parent block and of category “answer”. It is used to redefine a user answer. XML attribute id is optional for answer init is a data value of same type as the parent data element and of category “init”. It is used to give an initial/default value to an input component correct is a data value of same type as the parent data element and of category “correct”. It is used to specify the correct answers for the parent data element. This data fragment can be multi-valued. XML element use and XML attribute id are legal and optional for init and correct.

The following elements and attributes define the feedback for any data element. XML element feedback starts the feedback section. It consists of content data fragments (data, text, file) systematically selected whatever the answer to an input, and a combination of the XML elements described below. XML element isCorrect wraps the content (data, text, file) that is selected, if the answer matches one of the values specified in the correct data fragment of the same parent data element. XML element case is a more general form of isCorrect. It wraps the content (data, text, file) that is selected if the statement is true (can use ADL statements or script languages). XML element else is the same as XML element case; it is evaluated only if the previous case or else statement was false. When an else statement is true, the processor jumps to the next case element if any.

An example of an XML-based computer-processable specification language for describing functional logic of an interactive question-based application is an Application Description Language (ADL), which is specifically designed for this purpose. The basic data fragments and data elements in ADL are described below. ADL is designed to be used together with DDL (Data Definition Language) and with appropriate style language such as XSLT.

The terms and concepts referring to ADL document objects below in this Section 2.1 are introduced here. In ADL case, a data unit represents all the content contained in a single ADL object. A data unit consists of one or more data elements. In XML based ADL syntax, a data unit is everything enclosed in adl tag denoting the root element of the document. In ADL case, the data element can be either a variable or an action. In XML-based ADL syntax this means an element identified by a start tag and end tag. Data Fragment is the smallest piece of ADL. In XML-based ADL syntax this means attributes or primitive data elements.

ADL is a computer-processable specification language that is independent of the platform and implementation language. The actions relevant to question-based interactive applications comprise references to content data (DDL language element or fragment) and basic actions. Basic actions include control structures, logical operations, XML document management and evaluation and scheduling actions. The basic set of actions can be extended as required by a particular application type.

Following are examples of the control structures that can be used to specify such actions as branching and skipping in the application logic, such as questionnaire processing: If structure, Switch-Case-Else structure and While-Break structure.

Following are examples of the logical operations that provide a means for logical comparisons: Equal checks whether all the ‘indexed’ parameters, e.g. children values are equal and it is usually used inside. If and Break structures. And, Or and Not are the basic logical operators. The variable values can be set and read using Set and Get operations; Set sets the variable value in the parent action's environment.

Following are examples of the XML document management that can be used to manage any XML document, e.g. content data in DDL: XPath Searches or addresses a part of an XML document and Xslt makes transformation to an XML document.

Following are examples of managing or referencing to content data (DDL). Ddl.Select selects content data elements to be presented from a content data unit. Ddl.QuestionAmount returns the amount of data elements in a content data unit that can be presented as a question. Ddl.Send returns all selected content data elements so that style can be applied and the elements can be sent to the user. Ddl.Feedback returns all content data elements that present feedback to certain (or latest) user answer.

The following are examples of ADL evaluation, extension and scheduling. Execute executes actions returned by the children actions and it is useful with e.g. Compile action. Compile compiles a string into ADL action; the string to be compiled is the concatenation of the results of all children actions. Install installs a new action to the language from a non-ADL code, e.g. from Java class. Parameter name is the name of the new action type, and parameter type tells the implementation language. Wait pauses the execution of ADL code.

ADL syntax can be expressed in XML even though other languages, such as Java, are also possible. The syntax that is chosen typically depends at least on the following points: A human that writes ADL may choose a syntax he is most familiar with. A computer tool (concept editing tool) that helps to generate the application logic writes syntax that is most convenient for the program to write and modify. The implementation of the feedback architecture (ADL processor, Game platform . . . ) may be such that certain syntax is recommended (e.g. from the server performance point of view).

The ADL language references DDL data fragments in two different ways. Actions can directly reference a DDL data fragment by using its unique identification string if it exists. It is also possible to represent the DDL data unit as an XML DOM tree, and access the data fragments by visiting the tree nodes sequentially or searching for a specific XML attribute or element.

A variable may be defined in ADL in the following way: <var1 value=“zip”/> or <var1>zip</var1>. An action may be defined in the following way:

<action_name some_attr=“” another_attr=“”>

<any code>

</action_name>

Refence to a DDL element may be made in the following way. A content data management action may reference a DDL data element directly by <Ddl.Select id=“question1”/>. An XML document management action may reference DDL from the DDL's XML DOM tree representation:

<XPath document=“myDdl.ddl”>choice[@id=“123”]</XPath>”

While there may be different syntaxes used in particular implementation, these processing rules describe how the XML syntax of ADL code is typically executed. (1) The processing of XML code starts from the document element (‘Adl’). (2) Each XML element is an action that can be processed. The XML element name defines the action to be used. The action defines what happens when it is processed. (3) The attributes and child nodes of the XML element define parameters to the action. The XML attributes are parameters with name (like method parameters in Java), the attribute values are set as local variables to the action before processing it, and these parameters can be in any order. The XML child nodes are ‘indexed’ or ‘unnamed’ parameters (like parameters for Lisp statements), these parameters may be referred to by the action with an index and there can be any amount of these parameters. (4) The action itself defines what is done with the parameters and what effect their values have. (5) Common way of processing an action is the following: First all child nodes are processed one by one; each child node has its own local processing environment. The return values of each child node may or may not be stored to be used later. Finally the action itself acts. The environment's variable values and child node return values are usually used here. (5) The user of the ADL processor may initialize some variable values before calling the processor. When the ADL processor has finished processing the return value of the document element or any values of the document element's environment may be used. (6) An action may pause the execution of ADL code. The user of the ADL processor may then decide whether or when to continue.

Variables are processed in ADL typically in the following way. Variable values may be set in attributes, in other words by initialising a local variable, or by giving the variable name as an element. Variables may contain any datatype. Each action has its own environment. The environments are linked so that the environments parent environment is the parent action's environment. If the value for a variable ??? is not found from the environment, then search goes automatically to the parent environment. When setting a value for a variable, the search also goes upwards until the variable is found.

DDL and ADL are described here as examples; the invention is not restricted to these specific computer-processable specification languages. Furthermore, it is evident to a person skilled in the art that XML, for example, may be used to define other computer-processable spefication languages. The syntax presented above for DDL or ADL is also only as an example.

2.2. Role and Relationship of the Content, Action and Presentation Data Units

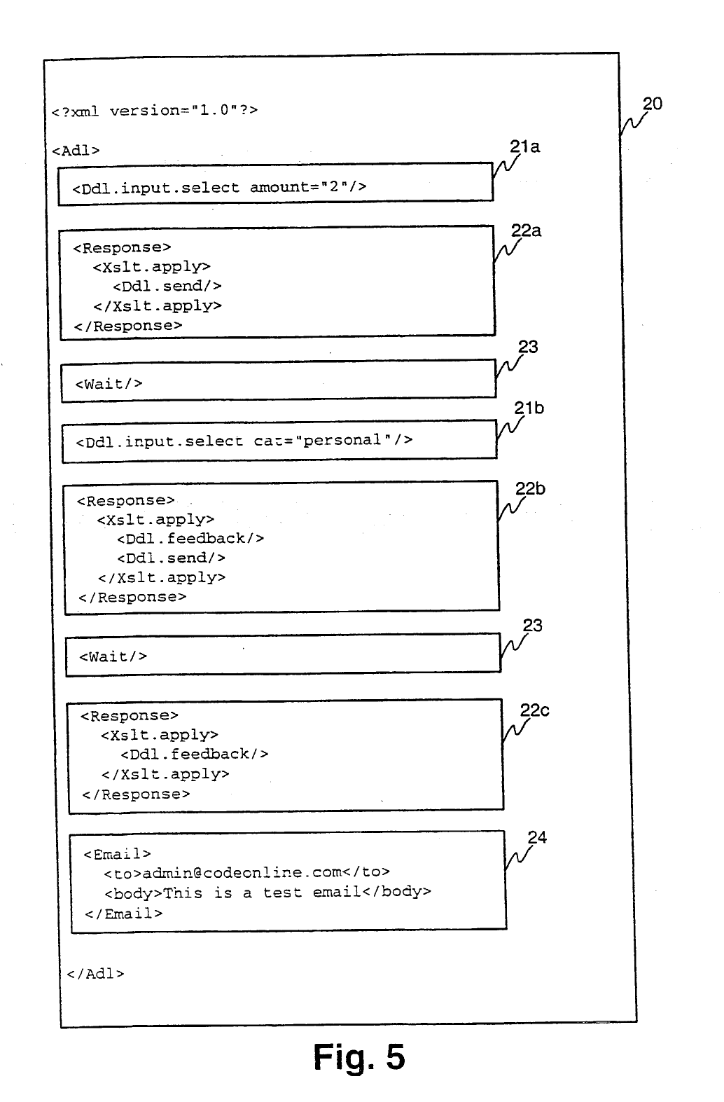

FIG. 4 illustrates the role and relationship of the various data units according to the invention. FIG. 4 illustrates a content data unit 10, which may be, for example, a DDL data unit; an action data unit 20, which may be, for example, an ADL data unit; and a presentation data unit 30, which may be, for example, an XSLT style sheet. In addition to these content action and presentation data units it is often advantageous to use a further data unit, a configuration data unit 50. A configuration data unit typically corresponds to a specific interactive question-based application. The data elements in this configuration unit 50 may define, for example: languages, in which the data content is available; content data units, which may be used in connection with this interactive question-based application; action data unit relating to this application; terminals or end-user devices, for which there is support for this interactive application; presentation data units relating to said terminals; timing properties (when the interactive question-based application is available; when results/analysis is available); and/or answer storing methods (not stored, first trial is stored, last trial is stored, all trials are stored). Instead of having a separate configuration data unit, it is possible to include the configuration information to an action data unit.

A system selects an action data unit and a content data unit, as specified typically in a configuration data unit. These three data unit specify an interactive question-based application in accordance with the invention. Thereafter the system selects and processes content data element in the content data unit according to the actions defined in the action data unit. The resulting data blocks are converted to a suitable format using a presentation data unit. Typically there is at least one presentation data unit for each terminal type, which a system in accordance with the invention supports.

2.3. Simple Questionnaire as an Example

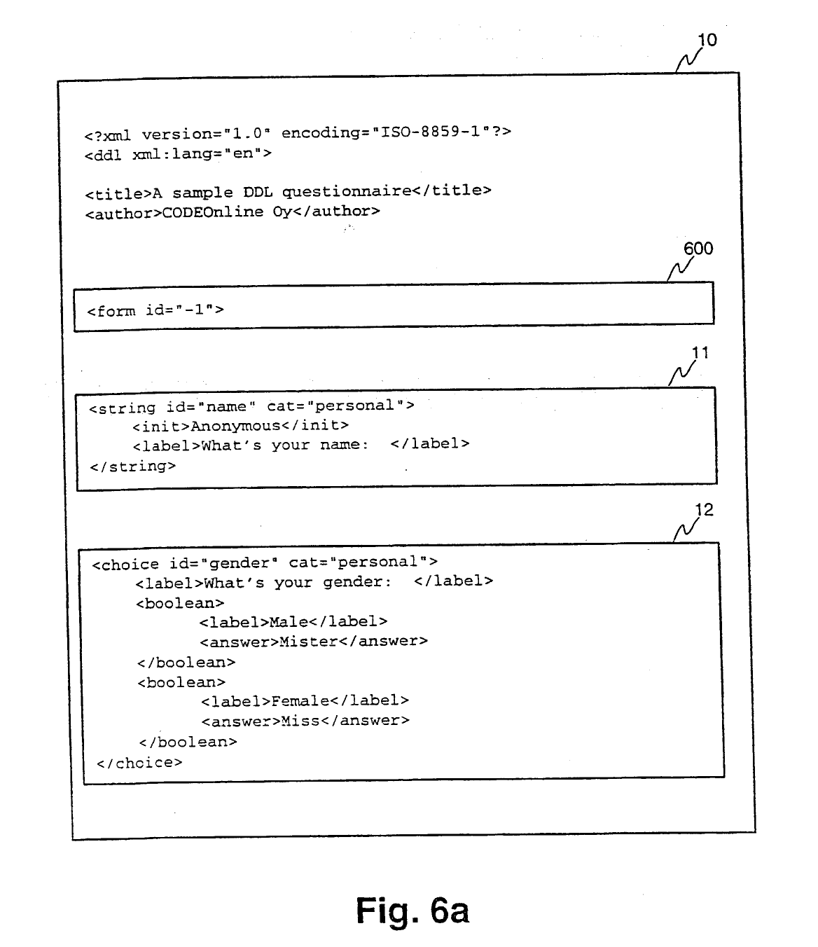

FIG. 5 illustrates, as an example, an ADL data unit 20, describing a simple questionnaire. This ADL data unit 20. which is presented in FIG. 5, has the following data elements defining actions: Action data element 21a defines that first two unasked questions of a content data unit are selected. Action data element 22a defines that the selected questions are presented to a user. Action data element 23 defines that the application waits for user input. Action data element 21b defines that all questions relating to category “personal” are selected from a content data unit Action data element 22b defines that feedback relating the questions, which were latest presented to the user (the two questions defined to be selected in action data element 22a), is given and current selected questions are presented to a user. Action data element 22c defines that feedback relating to the questions, which were latest presented to a user (personal questions), is given. The action data elements 22a, 22b and 22c illustrated in FIG. 5 indicate that XLST is used to process selected content data elements into presentable information. Action data element 24 defines that a test email is sent to a certain address. The actions defined by action data elements illustrated in FIG. 5 are carried out in the sequential order, in which they occur in the action data unit. In the ADL there are control structures defining conditional actions for branching and looping.

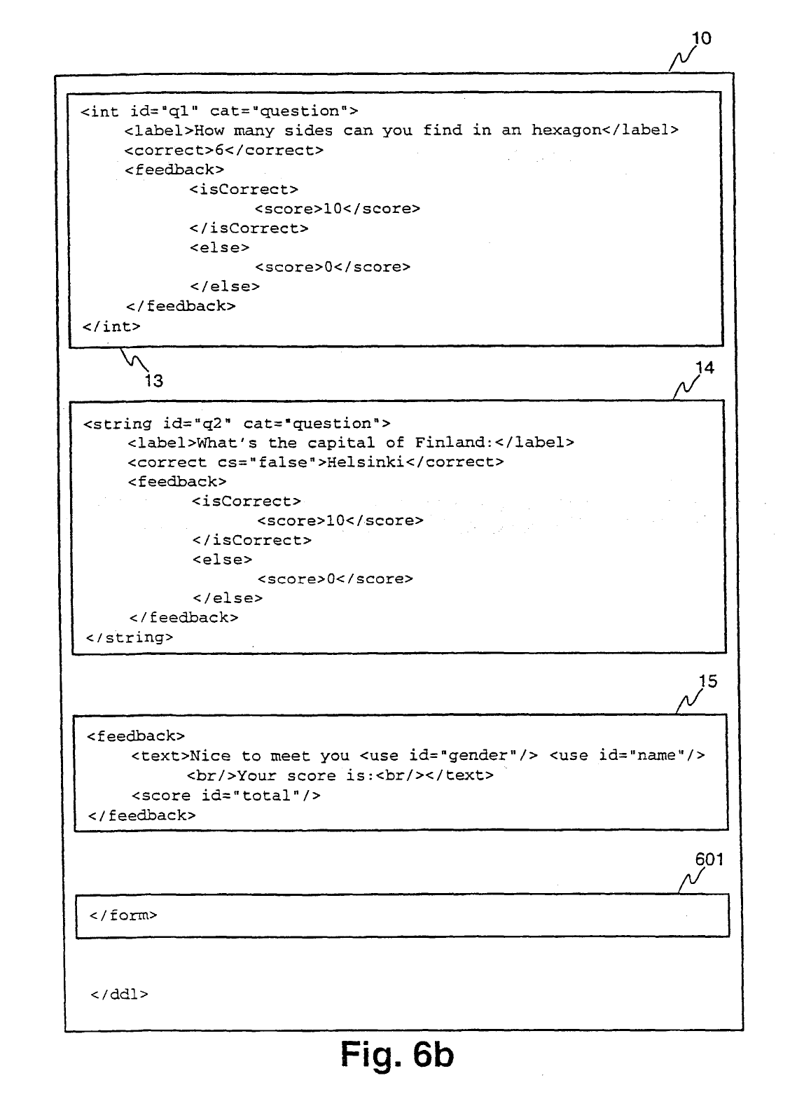

FIGS. 6a and 6b illustrate as an example, a DDL data unit 10, which is one possible content data unit relating to the ADL data unit presented in FIG. 5. In FIG. 6a, content data element 600 defines the beginning of a DDL form. Content data element 11 defines a question, whose answer is a free-text string, and whose category is “personal”. The label tags are used to define the presented question: “What's your name:”. Content data element 12 defines a single-choice question, where the answer options presented to a user are Male and Female. The corresponding actual answers, which the interactive application later may later use, are Mister and Miss. FIG. 6b illustrates the rest of this DDL data unit. Content data element 13 defines question “How many sides can you find in a hexagon”, whose answer is expected to have an integer value. The correct answer is defined using correct tags. The feedback for a correct answer is defined to be 10 points and for an incorrect answer 0 points. Content data element 14 defines question “What's the capital of Finland:”, whose answer is a case-insensitive string. The feedback is similar as in content data element 13. Content data element 15 defines feedback for the whole form, and content data element 601 defines the end of the form.

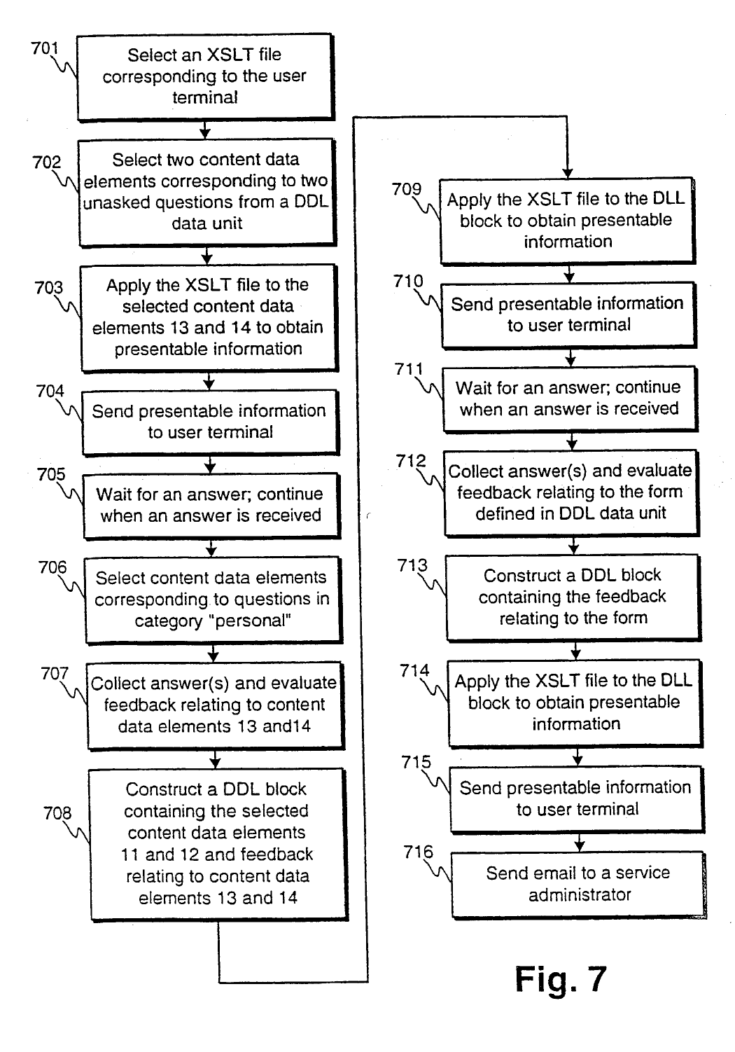

FIG. 7 illustrates the actions a system in accordance with the invention carries out, when it processes the action data unit 20 illustrated in FIG. 5 and content data unit 10 illustrated in FIGS. 6a and 6b. In step 701 the system selects an XSLT file, which corresponds to the terminal to which the information is to be sent. When a session is started, the type of the terminal is known typically from the communication protocol (for example, HTTP, one of Short Message Service Center Access protocols or X.25) using which a request to start a session is received. In step 702. the system selects as action data element 21a specifies two DDL data elements from a DDL data unit; said two DDL data elements corresponding to two unasked questions. In step 703, the system applies (as specified in ADL data element 22a) the selected XSLT file to the selected DDL data elements 13 and 14. which are illustrated in FIG. 6b. The result is presentable information suitable for display on the specific terminal, and in step 704 the presentable information is sent to the terminal, as specified in ADL data element 22a. In step 705 the system waits for an answer, as specified in the first ADL data element 23 illustrated in FIG. 5. In step 706 the system selects, as specified in ADL data element 21b, DDL data elements corresponding to questions in category “personal”. These DDL data elements are data elements 11 and 12 illustrated in FIG. 6a. In step 707 the system collects answers to information sent to a terminal in step 704, and evaluates feedback relating to DDL data elements 13 and 14 (as specified in ADL data element 22b). In step 708 the system contructs a DDL block containing the questions and answers of DDL data elements 11 and 12 and feedback relating to DDL data elements 13 and 14. These actions are specified in ADL data element 22b. In step 709, the system applies the selected XSLT file to the DDL block and in step 710 it sends presentable information to the terminal. These actions are also specified in ADL data element 22b. In step 711, the system waits for an answer. In step 712 it collects the answers relating to DDL data elements 11 and 12, and evaluates (as specified in ADL data element 22c) feedback to the whole DDL form using the feedback to the DDL data elements 11 and 12 and scores, which are calculated using feedback to DDL data elements 13 and 14. In step 713 the system constructs a DDL block comprising the feedback to the DDL form, in step 714 the selected XSLT file is applied to the DDL block, and in step 715 the resulting presentable information is sent to the terminal. These actions are defined in ADL data element 22c. In step 716, the system sends email to a service administrator, as specified in ADL data element 24 in FIG. 5.

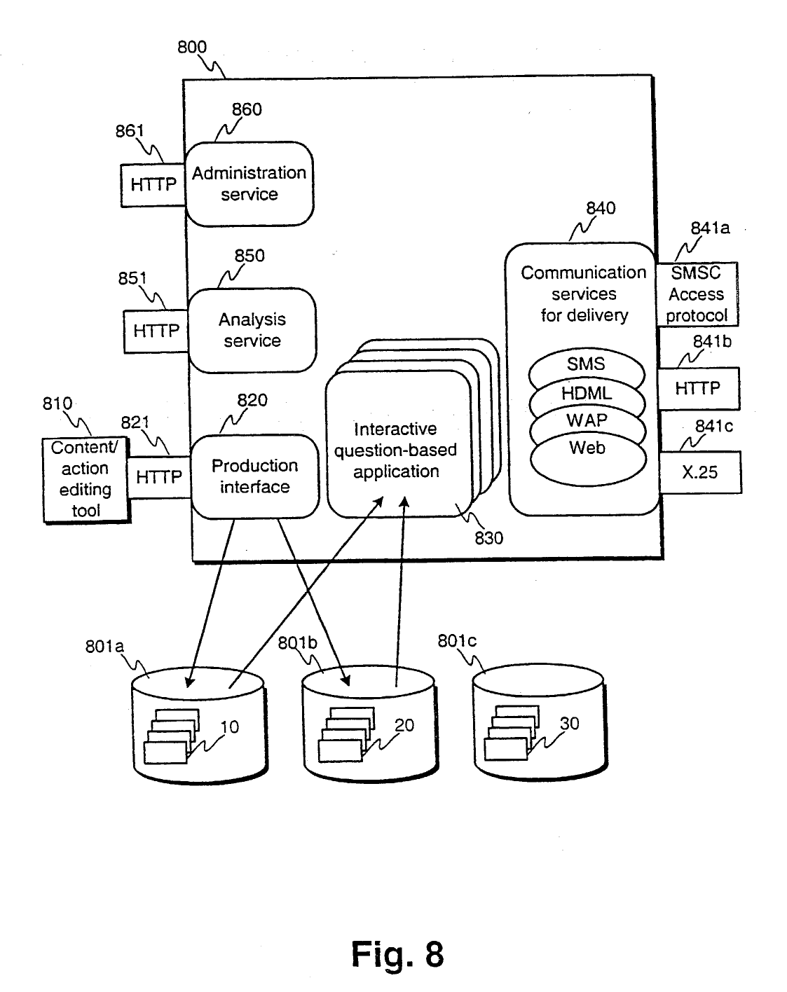

FIG. 8 illustrates schematically some services provided by a system 800 according to one advantageous embodiment of the invention. The system 800 comprises, as an example, databases 801a, 801b and 801c for storing content data units 10, action data units 20 and presentation data units 30. It is alternatively possible that these data units are stored in one database or that some of these data units are stored in other storage means (for example, as files on a disk) relating to the system 800. The system 800 typically comprises similar program code means 320, 340 as system 300 illustrated in FIG. 3. The services illustrated in FIG. 8 comprise the interactive question-based applications 830, communication services 840 for delivering the applications to users and production interface 820 for creating and/or modifying the content and/or actions data units using a content/action editing tool 810. The production interface 820. which is typically implemented as program code means for receiving content/action data units, receives information delivered using certain protocols 821. FIG. 8 presents HTTP as an example. The content/action editing tool 810 may be a batch authoring tool (e.g. Excel template), interactive standalone editor or a form available on the terminal for instant input. The content/action editing tool 510 may reside on a separate workstation, and created content/actions is typically transmitted over a data network via the production interface 810 to a database 801 or to other storage means.

If the functionality of interactive question-based applications is implemented using, for example ADL and specific interpreters, it is possible to store to a database also data units 20. The behaviour of the interactive question-based application can then be modified at execution time by modifying and interpreting the ADL action description. This also makes it possible to create and add new interactive applications to the system by users. The ADL description (file) can be edited either directly or by using an editing tool and taken into use while the application is in use. The changes affect only new session and existing ones continue to use the old one until they end. A production interface 820 may be used by various content providers and/or concept providers. Alternatively it is possible that separate interfaces and editing tools are provided for content and actions.

If the functionality of interactive question-based applications is implemented using some general programming language, such as Java., an ADL or other unambiguous description of an application is typically programmed to program code separately. In this case it typically is not possible to modify online the data elements 20, which are program code. We may use ADL as the interpreted computer-processable specification language that is used in the actual system, or only as a definition language for the implementation in another language such as Java—or the computer-processable specification language can use the syntax of Java.

In addition to production interface 820, there may be an analysis service and interface 850. This interface allows, for example, a concept provider or customer to monitor the use of a certain interactive question-based application. If a communication protocol 851, which the interface 850 supports is HTTP (as FIG. 8 illustrates as an example), the analysis service may be accessed via a browser. Furthermore, an administration service and interface 860 may be provided. These services are used for adding new applications, for starting and stopping them and for managing the users of the applications. Similarly as the analysis services, the administration services may be accessed using a browser. It is possible that the analysis and administration services and interfaces support also or alternatively other communication protocols than HTTP.

FIG. 8 illustrates also various communication services 840, which a system 800 may support, for delivering the interactive question-based applications to a user. As examples, FIG. 8 mentions SMS, HDML (Handheld Device Markup Language), WAP and Web. Various communication protocols 841 are presented, as examples, in FIG. 8; 841a is Short Messages Service Center Access protocol, 841b is HTTP and 841c is packet data network protocol X.25. A further example of a communication delivery service is interactive TV and related communication protocol.

The invention can be used in many different situations, where questions are asked from users, their answers are recorded, and some kind of feedback is given back to the users. The invention can be used for example in gallups, personnel questionnaires, voting, and in many other situations. The inventive system provides an easy way of creating new questionnaires and defining a new logic and/or new content for new or already existing questionnaires.

The invention can be used to support instant creation and publishing of interactive question-based games and other interactive question-based applications, such as surveys. Furthermore, the invention can be used to provide the end-user (consumer) generated interactive question-based applications, where end users (for example, a user group) can generate an application for their own use. It is possible to create games or other applications, where both game logic and content can be defined according to the need, on-the-fly. Examples of such applications comprise: event related games created based on the current situation (typical examples are sports events and TV program related games and surveys) and creation of ad-hoc games by end users to a peer group (typical examples include a community of users interested in a particular topic, such as golfers or football fans, or a group in social context, such as in a party or other gathering.

The elements of the system, which enable this instant creation of interactive question-based applications, include the elements described earlier: editing tools for defining content and/or logic for an application; production interface for content and/or concept uploading; storage of the uploaded application; possibility to start sessions relating to the uploaded application without any management or configuration procedure (supported especially by the online interpretation of computer-processable specification of the logic of an application); and communication services for presenting an application to end users via various communication networks to various terminals.

In view of the foregoing description it will be evident to a person skilled in the art that various modifications may be made within the scope of the invention. While some preferred embodiments of the invention have been described in detail, it should be apparent that many modifications and variations thereto are possible, all of which fall within the true spirit and scope of the invention.

1. Method (200) for providing interactive question-based applications over a communications network, characterized in that the method comprises the following steps:
defining (201) at least one question in a data unit of a first type, wherein the data unit of the first type comprises a plurality of first data elements defining data content for the interactive question-based application,
defining (202) in a data unit of a second type at least one action for processing questions in a data unit of the first type for producing presentable questions, wherein the data unit of the second type comprises a plurality of second data elements defining actions, and
defining (203) in a data unit of a third type rules for processing presentable questions for display on a specific type of terminal.

2. A method according to claim 1, characterized in that the data unit of the second type further defines the order, in which the second data elements defining actions are to be processed.

3. A method according to claim 2, characterized in that the data unit of the second type further comprises control structures defining conditional actions.

4. A method according to claim 1, characterized in that the method further comprises the step of:
carrying out (205) actions defined in at least some second data element belonging to said plurality of second data elements.

5. A method according to claim 4, characterized in that said step of carrying out actions comprises at least one of the following substeps:
selecting at least one first data element in the data unit of the first type, resulting in selected first data element(s),
processing selected first data element(s) using rules comprised in the data unit of the third type, resulting in presentable first data element(s) for display on a terminal of a certain type,
transmitting presentable first data element(s) to a terminal of said certain type, or
receiving an answer as a response to presentable first data element(s).

6. A method according to claim 1, characterized in that at least one of the first data elements comprises at least one of the following data fragments:
a data fragment defining a correct answer,
a data fragment defining a plurality of answer alternatives,
a data fragment defining feedback a correct answer, or
a data fragment defining feedback to answer alternatives.

7. A method according to claim 1, characterized in that at least one of the second data elements defines at least one of the following actions:
selection of one first data element from a data unit of the first type,
selection of a plurality of first data elements from a data unit of the first type,
processing of selected first data element(s) using a data unit of the third type,
transmission of selected processed first data element(s) to a user,
retrieval of user input to presented first data element(s), or
calculation of scores according to defined rules.

8. A method according to claim 1, characterized in that in the method,
said at least one question in data units of the first type is defined in a first computer-processable specification language,
said actions for processing are defined in data units of the second type in a second computer-processable specification language, and
said rules for processing a set of presentable questions are defined in data units of the third type in a third computer-processable specification language.

9. A method according to claim 8, characterized in that said first and second computer-processable specification languages are defined in the XML language.

10. A method according to claim 8, characterized in that said first computer-processable specification language is defined in the XML language and said second computer-processable specification language has the syntax of a general programming language.

11. A method according to claim 10, characterized in that said second computer-processable specification language uses the syntax of Java.

12. A method according to claim 8, characterized in that the method further comprises the step of:
storing answers obtained as a result of displaying questions in a fourth computer-processable specification language.

13. A method according to claim 12, characterized in that said first, second, third, and fourth languages are defined in the XML language.

14. A method according to claim 1, characterized in that the method further comprises the steps of:
processing at least a part of a data unit of the first type according to at least a part of the definitions in a data unit of the second type for producing presentable questions,
processing said presentable questions according to at least a part of the definitions in a data unit of the third type for display on a specific type of terminal, and
transmitting processed presentable questions to a terminal of said specific type.

15. A method according to claim 1, characterized in that said method further comprises the step of:
providing an editing tool for producing and/or modifying an interactive question-based application, said editing tool enabling the creation and/or modification of a data unit of the first type and/or a data unit of the second type.

16. A method according to claim 15, characterized in that said method further comprises the steps of:
receiving from an editing tool a data unit of the first type and/or a data unit of the second type, and
initiating a new interactive question-based application session after the receipt of data unit(s) from said editing tool, said session using the received data unit(s).

17. A method according to claim 1, characterized in that the terminal of said specific type is a mobile communication device.

18. A method according to claim 1, characterized in that the terminal of said specific type is a television set or a set-top-box of an interactive television with appropriate feedback device, such as remote controller.

19. A method according to claim 1, characterized in that the terminal of said specific type is a computer.

20. A method according to claim 1, characterized in that said method further comprises the step of:
defining an unambiguous description for functionality of said interactive question-based application,
and in that said at least one action is defined using said unambiguous description.

21. A method according to claim 20, characterized in that said unambiguous description is defined using an XML-based language.

22. System (300) for providing interactive question-based applications over a communications network, characterized in that said system comprises at least means for storing
a data unit (10) of a first type having the definition of at least one question, wherein the data unit of the first type comprises a plurality of first data elements defining data content for the interactive question-based application,
a data unit (20) of a second type comprising a plurality of second data elements having the definition of at least one action for processing of at least one question in a first data unit and for producing at least one presentable question, and
a data unit (30) of a third type having the definition of at least one rule for processing of a presentable question for display on a specific type of terminal; and
computer code means (320) for processing at least a part of a data unit of the first type according to at least a part of the definitions in a data unit of the second type for producing presentable questions,
computer code means (340) for processing presentable questions according to at least a part of the definitions in a data unit of the third type for display on a specific type of terminal, and
computer code means for transmitting processed presentable questions to a terminal of said specific type.

23. A system according to claim 22, characterized in that the computer code means for processing at least a part of a data unit of the first type comprise an Extensible Markup Language parser and an interpreter for a Extensible-Markup-Language-based language.

24. A system according to claim 22, characterized in that the computer code means for processing at least a part of a data unit of the first type comprise a program execution environment.

25. A system according to claim 24, characterized in that the program execution environment is Java Run-time Environment.

26. A system according to claim 22, characterized in that the system further comprises
computer program code means for receiving an answer to a question displayed to a user, and
computer program code means for storing received answers in a memory means.

27. A system according to claim 22, characterized in that the system further comprises
computer program code means for receiving information comprising definition of a question, and
computer program code means for storing received information comprising definition of a question in a data unit of the first type.

28. A system according to claim 22, characterized in that the system further comprises
computer program code means for receiving information specifying action definitions, and
computer program code means for storing specified action definitions in a data unit of the second type.

29. Computer program product for a system for providing interactive question-based applications over a communications network, characterized in that
the computer program product comprises at least
computer program code means for storing
a data unit of a first type having the definition of at least one question, wherein the data unit of the first type comprises a plurality of first data elements defining data content for the interactive question-based application,
a data unit of a second type comprising a plurality of second data elements having the definition of at least one action for processing of at least one question in a data unit of a first type and for producing at least one presentable question, and
a data unit of a third type having the definition of at least one rule for processing of a presentable question for display on a specific type of terminal; and
computer code means for processing at least a part of a data unit of the first type according to at least a part of the definitions in a data unit of the second type for producing presentable questions,
computer code means for processing presentable questions according to at least a part of the definitions in a data unit of the third type for display on a specific type of terminal, and
computer code means for transmitting processed presentable questions to a terminal of said specific type.

30. Computer program product according to claim 29, characterized in that it is stored on a computer readable medium.
